(19) United States
(12) Patent Application Publication
(10) Pub. No.: US 2003/0040297 A1
(43) Pub. Date: Feb. 27, 2003

(54) Advice of charge for communications services, architectures and methods therefor

(76) Inventors: Mark E. Pecen, Palatine, IL (US); Niels Peter Skov Andersen, Roskilde (DK); Jerome Vogedes, Waukesha, WI (US)

Correspondence Address: MOTOROLA INC, 600 NORTH US HIGHWAY 45, LIBERTYVILLE, IL, 60048-5343, US

(21) Appl. No.: 09/940,762

(22) Filed: Aug. 27, 2001

(51) Int. Cl. H04M 11/00

(52) U.S. Cl. 455/406; 455/405; 455/426

(57) ABSTRACT

Architectures and methods architectures for providing real-time cost information to communications applications, for example for transactions conducted by mobile wireless communications devices before the transaction is conducted. In one embodiment a communication transaction is selected at user equipment (UE) (302), a transaction cost request is communicated (304) from the application is to a communication server (306). In response, the server communicates (308) a firm or estimated cost to the UE. The cost may be based on subscription profile information obtained (312) from a source (314) and/or from information obtained (316) from a content provider (317). In some embodiments, the UE accepts or declines to conduct the transaction based on the cost.

### FIELD OF THE INVENTIONS

The present inventions relate generally to communications services, and more particularly to methods and architectures for providing users with real-time cost information for communications services, for example transactions in mobile wireless communications devices.

### BACKGROUND OF THE INVENTIONS

It is known in Global Mobile Communication Services (GSM) and Universal Mobile Telecommunications Services (UMTS) voice telephony standards to advise users of charges, in units of home public land mobile network (PLMN) cost, for a voice call while the voice call is in progress.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is an exemplary communication system including a mobile wireless communication device and a GPRS communication serving system coupled to a network.

FIG. 2 is an exemplary software implemented cost query flow diagram for a mobile wireless communication device.

FIG. 3 is an exemplary communication diagram.

FIG. 4 is an exemplary software implemented response flow diagram for a mobile wireless communication device.

FIG. 5 is an exemplary software implemented communication serving system flow diagram.

FIG. 6 is an exemplary software implemented content provider flow diagram.

### DETAILED DESCRIPTION OF THE INVENTIONS

The invention is drawn generally to methods and architectures for providing or offering communication transaction costs, for example cost estimates or firm quotes, to a user or application before the user or application conducts or participates in the transaction. The communication transaction may be a data transfer or information transfer, for example an upload or download, or a voice communication or a combination thereof. In some embodiments, the user or application is allowed to accept or decline the offer before conducting the transaction.

The inventions are applicable, for example, in the domain of mobile user data services and the transfer of information by user data interchange services, also referred to herein as communication serving systems, including the Global System for Mobile Communications (GSM), General Packet Radio Services (GPRS), Enhanced Data For Global Evolution (EDGE), 3rd Generation Mobile Data Services for Universal Mobile Telephone Service (UTMS), among other services, which support wireless data communications, including voice and/or data services, for example wireless application protocol (WAP) enabled services. More generally, the communication system is an application that communicates with a server. The inventions are also applicable to wire-line communication systems, and may be particularly suitable for bandwidth limited applications.

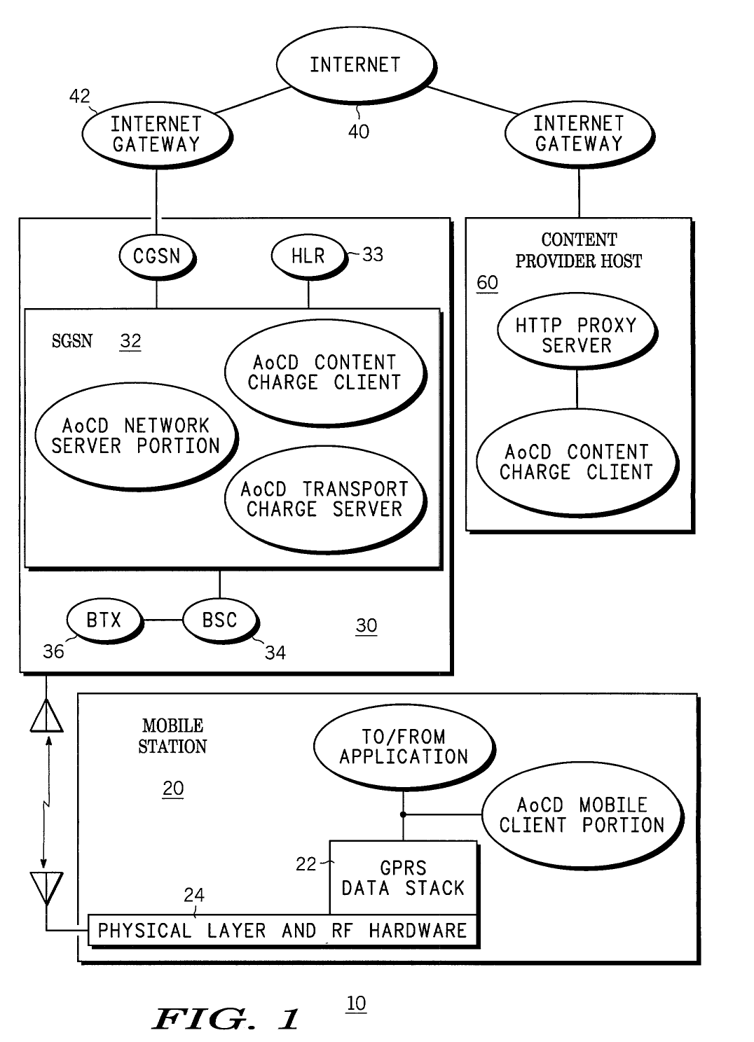

FIG. 1 is an exemplary GPRS communication system 10 comprising a mobile wireless communication device 20 in radio frequency communication with a serving GPRS support node (SGSN) 30 coupled to the Internet 40 by a gateway 42, which has coupled thereto a content provider 60.

The exemplary GPRS enabled mobile device 20, also referred to as a mobile station (MS) or user equipment (UE), comprises generally a GPRS data stack 22 coupled to a physical layer and RF hardware 24. The mobile device 20 includes a software controlled processor and operates applications, for example a web browser, games, interactive software, as is known generally by those of ordinary skill in the art.

The exemplary GPRS communications serving system 30 comprises generally a serving GPRS support node (SGSN) 32 is coupled to a home location register (HLR) 33 and to a base station controller (BSC) 34 coupled to a base station transceiver 36, as is known generally by those of ordinary skill. The SGSN 32 is also coupled to a gateway GPRS support node (GGSN) 38 coupled to the gateway 42, as is also known.

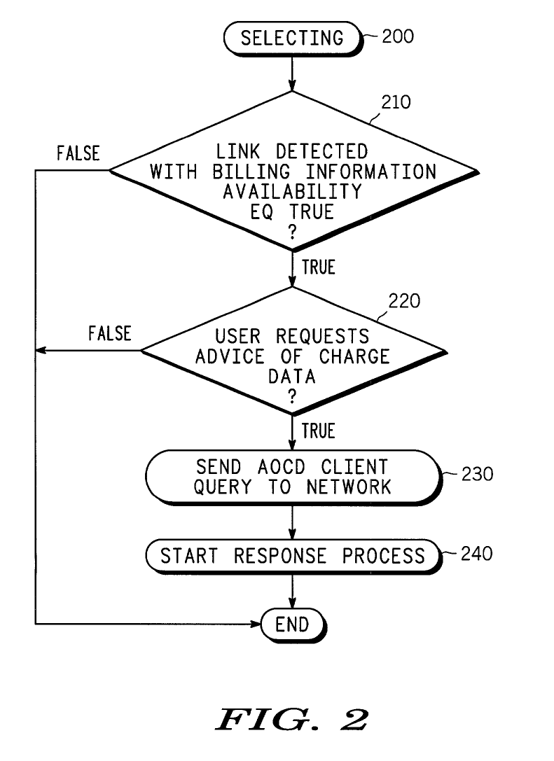

In FIG. 2, the user equipment, or application, begins generally by identifying a transaction, for example by selecting an MP3 file to be downloaded from an Internet content provider, at block 200. In a preferred embodiment, a determination is made at decision block 210 whether billing or cost information is available for the information selected. In the exemplary MP3 download embodiment, the content provider may have a pre-established relationship with the communication serving system for providing MP3 file download cost information to the user.

In FIG. 2, if cost information is not available, the program ends, and in some embodiments the user is informed that the information is unavailable, for example by signaling the user, for example with a display or audible signal, at the mobile device or application.

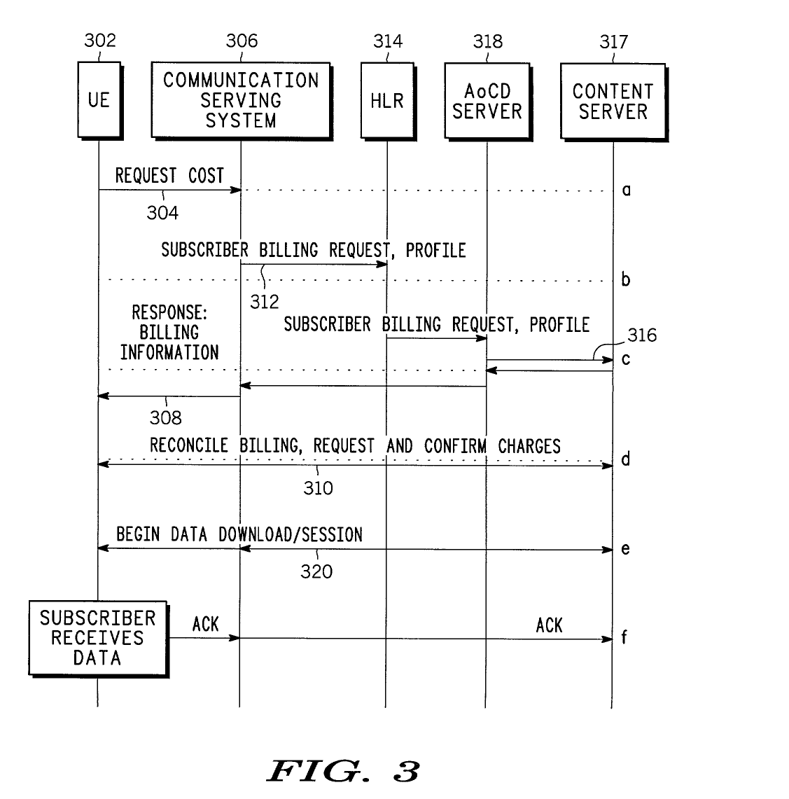

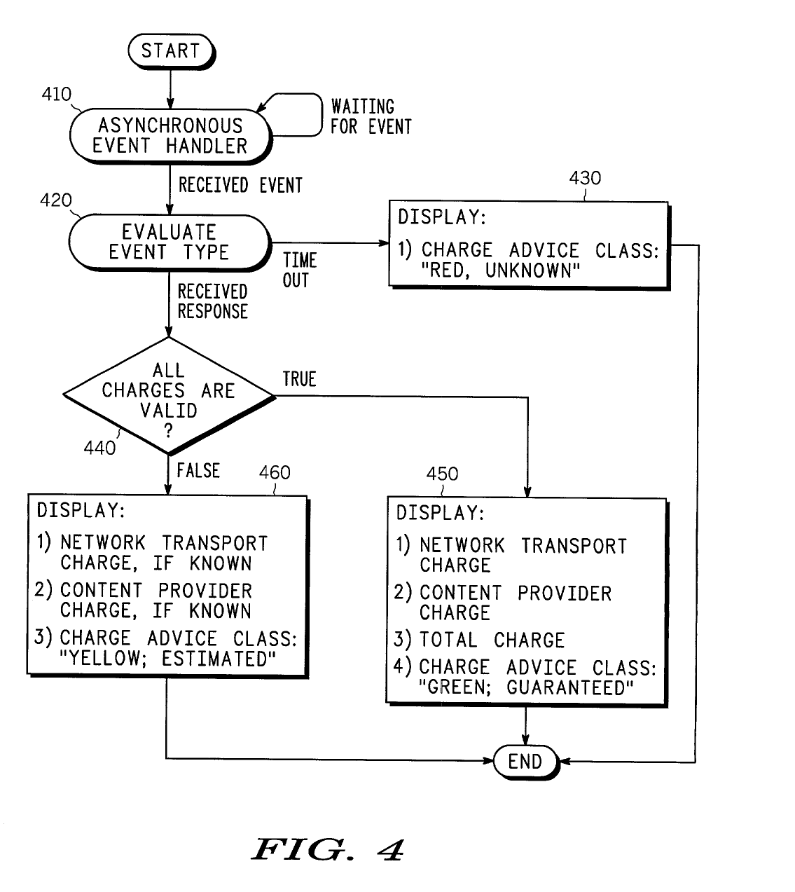

In FIG. 2, if cost information is available, the application or mobile device selects to requests the cost information at block 220 and the request is communicated or transmitted to the communication serving system at block 230. In FIG. 3, a UE 302 communicates a cost request 304 from a communications serving system 306. In FIG. 3, the response process occurs at block 240, an exemplary diagram of which is illustrated in FIG. 4 and discussed below.

In FIG. 4, the application or mobile device waits for a response to the request at block 410. At block 420, if a reply is not received within a specified time period, the program ends after the time out period. In some embodiments, the user is informed that the information is unavailable at block 430.

In FIG. 3, a response 308 from the communication server is transmitted to the application or user. In FIG. 4, at block 440, a determination is made at block 440 whether the cost offer response is firm, or guaranteed. A guaranteed cost is communicated to the user or application at block 450 and an estimated cost is communicated to the user at block 460. In the exemplary embodiment, the estimated and guaranteed costs are indicated, for example displayed or announced audibly for user consumption. In some embodiments, it is not necessary to communicate the cost to the user. The cost information may also be stored for later analysis.

In one embodiment, the application or mobile device accepts the cost offer before conducting the transaction or declines the cost offer by responding to the request at 310. In FIG. 3, in some applications, a prompt is provided at the application or at the mobile wireless communication device allowing a user to manually accept or reject the cost received, for example by responding to the prompt with a key input. In another embodiment, the acceptance or rejection is made automatically, for example by software that sends an acceptance or rejection upon comparing the cost offer or estimate to some reference, without user input.

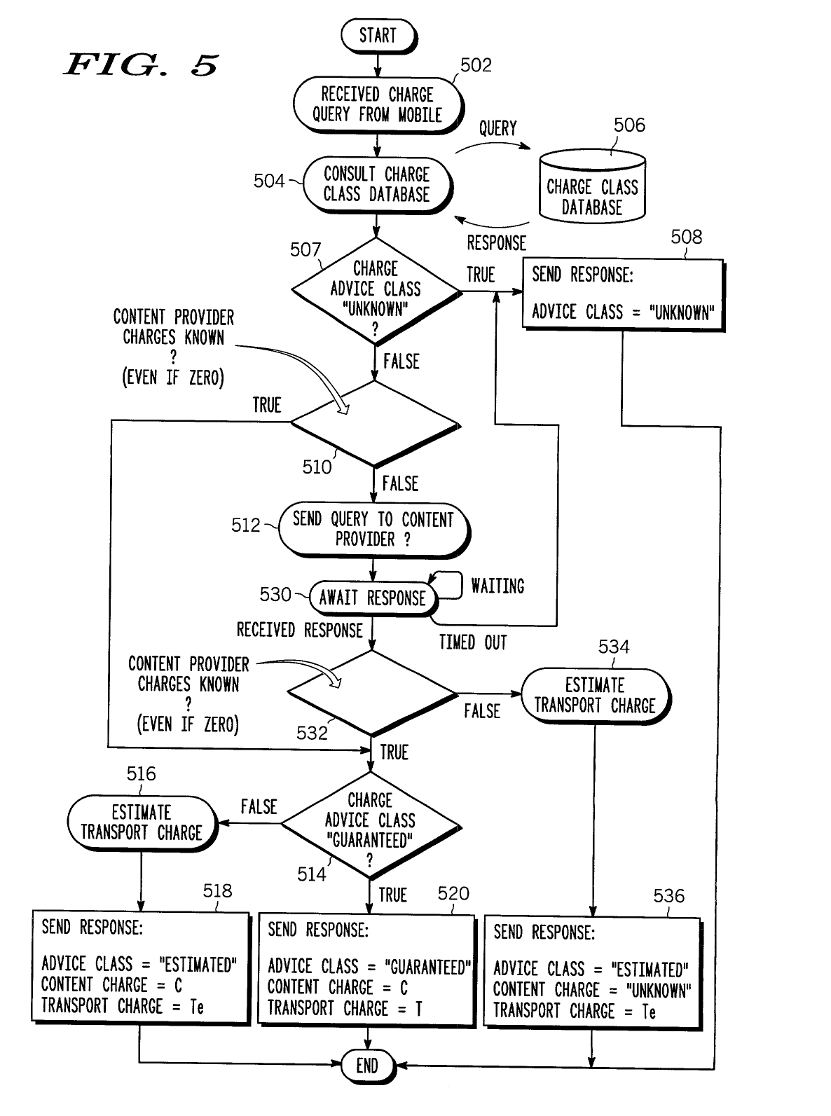

In FIG. 5, from the viewpoint of the exemplary communication serving system a request is received, at block 502, at the communication serving system for a wireless transaction cost from the mobile wireless communication device. Generally, in response to the request, the communication serving system provides a wireless transaction cost to the mobile wireless communication device before the wireless mobile communication device conducts the wireless transaction for which the cost or estimate is provided.

Generally, the transaction cost may have a content component, for example in embodiments where content is downloaded or consumed, and/or a content transport or communication service component, as discussed more fully below. In some embodiments, the cost information is broken down into its components, and in other embodiments the cost is unitary, as illustrated at block 450 and 460 of FIG. 4.

In one embodiment, the cost is based on a time of the transaction, for example peak or off-peak hours, or on the amount of information, for example, the number of bytes or octets, uploaded or down-loaded in a data transfer operation. The cost may also be dependent upon the temporal dimension of the transaction. In some embodiments however, there is no cost, for example, in return for accepting advertisement information.

In one embodiment, the cost is based on subscription information associated with the communication application or mobile device. In FIG. 5, in response to the query, at block 504, the serving system consults a charge class database 506 to obtain subscription information of the mobile device or application. In the exemplary GPRS application of FIG. 3, the serving system 306 submits a request 312 for a communication service subscription information profile from a home location register (HLR) 314. The subscription information may for example dictate the content transport component of the transaction.

In FIG. 5, if the charge class information is unavailable, at decision block 507, an appropriate response is communicated to the requestor at block 508. If the charge class is known, or not considered, a decision is made at block 510 as to whether there are any content provider charges associated with the transaction, which may be the case if there is a data transfer, for example in the exemplary MP3 file download scenario. If there is a content charge and it is not known a content charge request is made to the content provider at block 512.

In some embodiments, however, the content cost component is already known, for example by a prior agreement between the content provider and the serving system, so that the content provider inquiry is not necessary. If the content charge is known, a determination is made at decision block 514 as to whether the transport cost component is guaranteed. If not, the transport cost component is estimated at block 516, and then the estimated cost is communicated at block 518 to the application or to the mobile device. If the transport cost component is guaranteed at block 516, then the cost is communicated at block 520 to the application or to the mobile device.

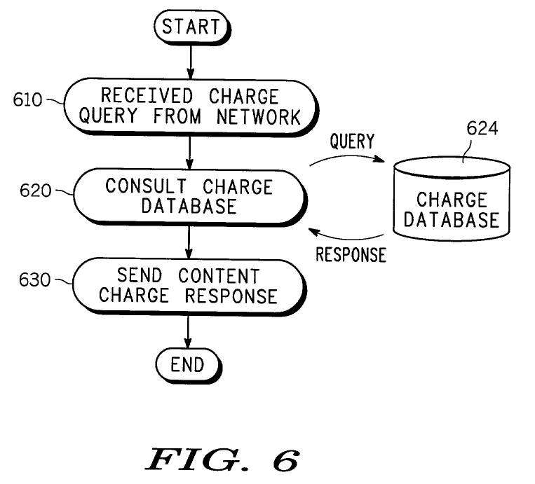

In FIG. 6, in response to the request from the communication serving system, at block 512 of FIG. 5, the content provider receives the request from the communication network at block 610. The request may include service subscriber profile information. In FIG. 3, for example, a request 316 includes user information from the HLR communicated to the content server 317 via server 318.

In FIG. 6, the content cost is determined, for example by consulting at block 620 a charge database 624, which may contain content cost information, and/or user content subscription information corresponding to the user information received from the communication system server. At block 630, the content cost component is communicated to the communication server, which is awaiting the response at block 530 in FIG. 5. The system defaults to block 508, discussed above, if a response is not received at block 530 within a specified time.

In FIG. 5, at decision block 532, upon receipt of a reply from the content server, a determination is made at block 532 whether the content provider charge is know, similar to the decision of block 510, discussed above. In one embodiment, if the content charge is known at block 532, the process proceeds to block 5314 discussed above, and if the content charge is not known the process proceeds to block 534, where the transport charge is estimated, and then to block 536 where the costs are communicated to the application or to the mobile device.

As discussed and suggested above, there is substantial flexibility in how the cost is determined. In other embodiments, the cost offer is based at least partly on a credit to a user, for example a user account, of the communication application or mobile device for conducting the transaction. The credit scheme could be, for example, in the form of rebates or discount coupons, for purchases from content providers, or in return for accepting advertisement banners, or as part of a product or service trial offer.

In another embodiment, the transaction is an interactive transaction, for example games or services, like virtual banking. In these embodiments, the cost offer may be based at least partly on an interactive transaction performance by the communication application or by the user of the mobile wireless device.

In FIG. 3, upon accepting or acknowledging the transaction cost at the application or mobile device, the transaction is conducted at 320.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in communication application, comprising:
identifying a communication transaction at the communication application;
transmitting a request from the communication application to a communication server for a cost to conduct the transaction;
receiving from the communication server, in response to the request, a cost offer for the transaction before the communication application conducts the transaction.

2. The method of claim 1, identifying a transaction by making a selection at the communication application.

3. The method of claim 1, indicating the cost offer at the communication application.

4. The method of claim 1, accepting the cost offer at the communication application before conducting the transaction.

5. The method of claim 1, receiving from the communication server a cost offer based on at least one of a time of the transaction, an amount of information of the transaction, and subscription information associated with the communication application.

6. The method of claim 1, receiving from the communication server a cost offer based at least partly on a credit to a user of the communication application for conducting the transaction.

7. The method of claim 1, the transaction is an interactive transaction, receiving from the communication server a cost offer based at least partly on an interactive transaction performance at the communication application.

8. A method in a mobile wireless communication device, comprising:
identifying a wireless transaction at the mobile wireless communication device;
transmitting a request from the mobile wireless communication device to a network for a cost to conduct the wireless transaction;
receiving from the network, in response to the request, a cost to conduct the wireless transaction before conducting the wireless transaction.

9. The method of claim 8, indicating the cost at the mobile wireless communication device.

10. The method of claim 8, providing a prompt at the mobile wireless communication device for accepting or rejecting the cost received.

11. The method of claim 8, identifying the wireless transaction by making a selection at the mobile wireless communication device.

12. The method of claim 8, the wireless transaction is a data download to mobile wireless communication device via the network, receiving from the network a cost based at least partly on at least one of a time interval required to download the data, a number of octets to be received by the mobile wireless communication device.

13. The method of claim 8, the wireless transaction is an information download to the mobile wireless communication device via the network, receiving from the network a cost based at least partly on a credit to an account of the mobile wireless communication device for downloading the information.

14. The method of claim 8, the wireless transaction is a data download to mobile wireless communication device via the network, receiving from the network a cost based at least partly on an amount of data to be downloaded over a time interval by the mobile wireless communication device.

15. The method of claim 8, the wireless transaction is an interactive transaction, receiving from the network a cost based at least partly on an interactive transaction performance at the mobile wireless communication device.

16. The method of claim 8, the wireless transaction is an interactive transaction, receiving from the network a cost based at least partly on participation in the interactive transaction at the mobile wireless communication device.

17. A method for providing wireless transaction cost information to a mobile wireless communication device, comprising:
receiving a request at a communication serving system for a wireless transaction cost from the mobile wireless communication device;
providing a wireless transaction cost to the mobile wireless communication device, in response to the request, before the wireless mobile communication device conducts the wireless transaction for which the cost is provided.

18. The method of claim 17, receiving a wireless transaction cost acceptance from the mobile wireless communication device before the mobile wireless communication device conducts the wireless transaction.

19. The method of claim 17, the wireless transaction is an information download to the mobile wireless communication device, generating the wireless transaction cost based on at least one of a time interval required to download the information, an amount of information to be downloaded by the mobile wireless communication device over a time interval, and a subscription information of the mobile wireless communication device.

20. The method of claim 17, generating the wireless transaction cost based on at least one of a content of the transaction and a content transport charge.

21. The method of claim 17, the wireless transaction is an interactive transaction, generating the wireless transaction cost based at least partly on one of an interactive transaction performance at the mobile wireless communication device and a participation in the interactive transaction at the mobile wireless communication device.

22. The method of claim 17, the wireless transaction is an advertisement transfer to the mobile wireless communication device, generating the wireless transaction cost based at least partly on a credit to an account of the mobile wireless communication device for downloading the advertisement.
